(19) United States
(12) Patent Application Publication
(10) Pub. No.: US 2025/0062395 A1
(43) Pub. Date: Feb. 20, 2025

(54) DUAL-LAYER ELECTROLYTE

(71) Applicant: GM GLOBAL TECHNOLOGY OPERATIONS LLC, Detroit, MI (US)

(72) Inventors: Qili Su, Shanghai (CN); Zhe Li, Shanghai (CN); Haijing Liu, Shanghai (CN); Yong Lu, Shanghai (CN); Xiayin Yao, Zhejiang (CN); Dingcheng Guo, Zhejiang (CN)

(21) Appl. No.: 18/474,540

(22) Filed: Sep. 26, 2023

(30) Foreign Application Priority Data
Aug. 18, 2023 (CN) 202311049417.2

(51) Int. Cl. H01M 10/0562; H01M 4/38; H01M 4/62

(52) U.S. Cl. CPC H01M 10/0562; H01M 4/382; H01M 4/623; H01M 2004/027; H01M 2300/002; H01M 2300/0094

(57) ABSTRACT

An electrolyte for use in an electrochemical cell. The electrolyte includes a first layer having a thickness of about 1 μm to about 40 μm and a second layer having a thickness of about 5 μm to about 60 μm. The first layer includes, based on a total weight of the first layer, about 10 wt. % to about 40 wt. % of first solid-state electrolyte particles, about 1 wt. % to about 15 wt. % of lithium, and about 1 wt. % to about 65 wt. % of fibrils including carbon and fluorine, The second layer includes second solid-state electrolyte particles.

### CROSS-REFERENCE TO RELATED APPLICATIONS

This application claims priority to Chinese Patent Application No. 202311049417.2, filed Aug. 18, 2023, and all the benefits accruing therefrom under 35 U.S.C. § 119, the contents of which in its entirety are herein incorporated by reference.

### INTRODUCTION

The present disclosure relates to solid-state batteries and methods of forming the same. More particularly, the present disclosure relates to electrolytes, for example, sulfide electrolytes, having improved electrochemical and mechanical stabilities, and methods of making the same.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

An all-solid-state battery (ASSB), for example, a lithium-ion battery (LIB) including a sulfide solid-state electrolyte, may provide desirable abuse tolerance, power capability, and working temperature range. However, electrochemical instability between an anode layer and the solid-state electrolyte layer may increase cell resistance and poor mechanical stability related to lithium dendrites growth upon cycling may exist. Accordingly, it is desirable to provide solid-state electrolyte layers having improved electrochemical and mechanical stabilities, and methods of making the same.

### SUMMARY

In one exemplary embodiment, the present disclosure provides an electrolyte for use in an electrochemical cell. The electrolyte may include first solid-state electrolyte particles and fibrils including carbon and fluorine that provides a structural framework for the first solid-state electrolyte particles.

In addition to one or more of the features described herein, the electrolyte includes a first layer having a thickness of about 1 micrometer (μm) to about 40 μm and a second layer having a thickness of about 5 μm to about 60 μm. The first layer may include, based on a total weight of the first layer: about 10 weight percent (wt. %) to about 40 wt. % of first solid-state electrolyte particles, about 1 wt. % to about 15 wt. % of lithium, and about 1 wt. % to about 65 wt. % of fibrils including carbon and fluorine. The second layer may include second solid-state electrolyte particles.

In another exemplary embodiment, the first layer may further include greater than 0 to about 60 wt. % of an electrically conductive material.

In yet another exemplary embodiment, the first solid-state electrolyte particles may be selected from the group consisting of: solid-state sulfide electrolyte particles, solid-state halide electrolyte particles, solid-state hydride electrolyte particles, and combinations thereof.

In yet another exemplary embodiment, the second solid-state electrolyte particles may be selected from the group consisting of: solid-state sulfide electrolyte particles, solid-state halide electrolyte particles, solid-state hydride electrolyte particles, and combinations thereof.

In yet another exemplary embodiment, the fibrils including carbon and fluorine may include polytetrafluoroethylene (PTFE).

In yet another exemplary embodiment, the fibrils including PTFE may be present in an amount of about 1 wt. % to about 50 wt. %, based on a total weight of the first layer.

In yet another exemplary embodiment, the lithium may be present in the form of a lithium foil, stabilized lithium metal powder, lithium metal, or a combination thereof.

In yet another exemplary embodiment, the first layer may further include a lithium anode material.

In yet another exemplary embodiment, the fibrils including carbon and fluorine may further include lithium.

In yet another exemplary embodiment, the first layer may further include a lithium anode material.

In one exemplary embodiment, the present disclosure provides an electrochemical cell that cycles lithium ions. The electrochemical cell may include an electrolyte including a first layer having a thickness of about 1 μm to about 40 μm. and a second layer having a thickness of about 5 μm to about 60 μm. The first layer may include, based on a total weight of the first layer: about 10 wt. % to about 40wt. % of first solid-state electrolyte particles, about 1 wt. % to about 15 wt. % of lithium, about 1 wt. % to about 65 wt. % of fibrils including carbon and fluorine, and greater than 0 to about 60 wt. % of an electrically conductive material. The second layer may include second solid-state electrolyte particles.

In addition to one or more of the features described herein, the first solid-state electrolyte particles may be selected from the group consisting of: solid-state sulfide electrolyte particles, solid-state halide electrolyte particles, solid-state hydride electrolyte particles, and combinations thereof.

In another exemplary embodiment, the second solid-state electrolyte particles may be selected from the group consisting of: solid-state sulfide electrolyte particles, solid-state halide electrolyte particles, solid-state hydride electrolyte particles, and combinations thereof.

In yet another exemplary embodiment, the electrochemical cell may further include at least one first electrode. The at least one first electrode may include first solid-state electroactive particles and third solid-state electrolyte particles.

In yet another exemplary embodiment, the electrochemical cell may further include at least one second electrode. The at least one second electrode may include second solid-state electroactive particles, third solid-state electrolyte particles, and fourth solid-state electrolyte particles. The second solid-state electroactive particles may be different from the first solid-state electroactive particles.

In yet another exemplary embodiment, the fibrils including carbon and fluorine may include PTFE.

In yet another exemplary embodiment, the fibrils including carbon and fluorine may further include lithium.

In one exemplary embodiment, the present disclosure provides an electrolyte for use in an electrochemical cell. The electrolyte may include a first layer having a thickness of about 1 μm to about 40 μm and a second layer having a thickness of about 5 μm to about 60 μm. The first layer may include, based on a total weight of the first layer: about 10 wt. % to about 40 wt. % of first solid-state electrolyte particles, wherein the first solid-state electrolyte particles may include solid-state sulfide electrolyte particles; about 1 wt. % to about 15 wt. % of lithium; about 1 wt. % to about 65 wt. % of fibrils including carbon and fluorine; and greater than 0 to about 60 wt. % of an electrically conductive material. The second layer may include second solid-state electrolyte particles.

In addition to one or more of the features described herein, the first solid-state electrolyte particles may further include solid-state halide electrolyte particles, solid-state hydride electrolyte particles, or a combination of solid-state halide electrolyte particles and solid-state hydride electrolyte particles.

In another exemplary embodiment, the fibrils including carbon and fluorine may be prepared from a starting PTFE material having an average particle size greater than or equal to about 2 μm to less than or equal to about 2,000 μm.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration showing formation of an electrolyte layer in accordance with an aspect of the present disclosure;

FIG. 2 is an illustration showing formation of an electrolyte layer in accordance with an aspect of the present disclosure;

FIG. 3 is an illustration showing formation of an electrolyte layer in accordance with an aspect of the present disclosure;

FIG. 4 is an illustration showing formation of an electrolyte layer in accordance with an aspect of the present disclosure;

FIG. 5 is an illustration of a portion of a battery in accordance with an aspect of the present disclosure;

FIG. 6 is a scanning electron microscopy (SEM) image of a Comparative Example;

FIG. 7 is a SEM image of an Example;

FIG. 8 is a graphical illustration representing x-ray photoelectron spectroscopy (XPS) analysis of the first layer of the Example;

FIG. 9 is a graphical illustration demonstrating electrochemical performance of the Comparative Example;

FIG. 10 is a graphical illustration demonstrating electrochemical performance of the Comparative Example; and

FIG. 11 is a graphical illustration demonstrating electrochemical performance of the Comparative Example and the Example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, an electrolyte for solid-state batteries (SSBs), and methods of forming and using the same are disclosed. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

A solid-state battery (SSB) may include an anode including graphite and Li₆PS₅Cl (LPSCl) in a weight ratio of 6:4 graphite:LPSCl, a cathode including a composition of 50% nickel, 30% manganese, and 20% cobalt (NCM523) and LPSCl in a weight ratio of 7:3 NCM523:LPSCl, and an electrolyte therebetween including LPSCl. An interfacial side reaction may occur between the solid electrolyte (LPSCl) and anode, which may result in poor electrochemical stability (e.g., 1.7 volts (V)) of sulfide. Also, dendrite may grow along the solid electrolyte (LPSCl) (e.g., adjacent to the anode). There may be a low kinetic energy between the anode material and the sulfide electrolyte (LPSCl). An interface that may be formed by side reaction between the solid electrolyte and anode may be ineffective to inhibit dendrite growth and an internal short may occur after cycling.

Accordingly, there may electrochemical instability between the anode and the solid-state electrolyte and mechanical instability with lithium dendrite growth across an interface upon cycling. Lithium may be become inactive if lithium dendrite grows within the solid electrolyte and internal short may occur if lithium dendrite growth spans from the anode and reaches the cathode. An electrochemically and mechanically stable electrolyte layer is desired for extended solid-state battery cycling.

The disclosed dual-layer electrolyte includes a first layer (also referred to herein as a “protection layer”) and a second layer (also referred to herein as a “solid electrolyte” layer). The first layer may provide mechanical and/or electrochemical stability. A robust fibril framework within the first layer may provide mechanical stability.

In certain variations, the starting polymer or polymer binder (e.g., that generates or forms PTFE fibrils), may have an average particle size greater than or equal to about 2 μm to less than or equal to about 2,000 μm, and in certain aspects, greater than or equal to about 300 μm to less than or equal to about 800 μm, or greater than or equal to about 400 μm to less than or equal to about 700 μm. Notably, polyvinylidene fluoride (PVDF), polypropylene (PP), and polyethylene (PE) materials have not been found to prepare usable fibrils.

Hereinafter, while reference may be made to PTFE fibrils, it should be understood that any suitable polymer may be used to form the fibrils. For example, other suitable polymers include fluorinated ethylene propylene (FEP), perfluoroalkoxy (PFA), ethylene tetrafluoroethylene (ETFE), or a combination thereof. Additional polymers with desirable film forming properties and high film elongate rate under calendaring include, for example, polyvinylidene fluoride-hexafluoropropylene (polyvinylidene fluoride-co-hexafluoropropylene), polyvinylidene fluoride-trichlorethylene (polyvinylidene fluoride-cotrichlorethylene), polymethylmethacrylate, Polyacrylonitrile, polyvinylpyrrolidone, polyvinylacetate, ethylene-co-vinyl acetate, polyethylene oxide, cellulose acetate, cellulose acetate butyrate, cellulose acetate propionate, cyanoethylpullulan, cyanoethylpolyvinylalcohol, cyanoethylcellulose, cyanoethyl sucrose, pullulan, carboxyl methyl cellulose, acrylonitrile-styrene-butadiene copolymer, and polyimide.

The PTFE fibrils may have an average length of greater than or equal to about 2 μm to less than or equal to about 100 μm. The PTFE fibrils may have an average length of greater than or equal to about 2 μm to less than or equal to about 100 μm. The PTFE fibrils may have a softening point of greater than or equal to about 270° C. to less than or equal to about 380° C. The PTFE fibrils may have a softening point of greater than or equal to 270° C. to less than or equal to 380° C. The molecular weight of the PTFE fibrils may be greater than or equal to about 10⁵ grams per mole (g/mol) to less than or equal to about 10⁹ g/mol. The molecular weight of the PTFE fibrils may be greater than or equal to 10⁵ g/mol to less than or equal to 10⁹ g/mol.

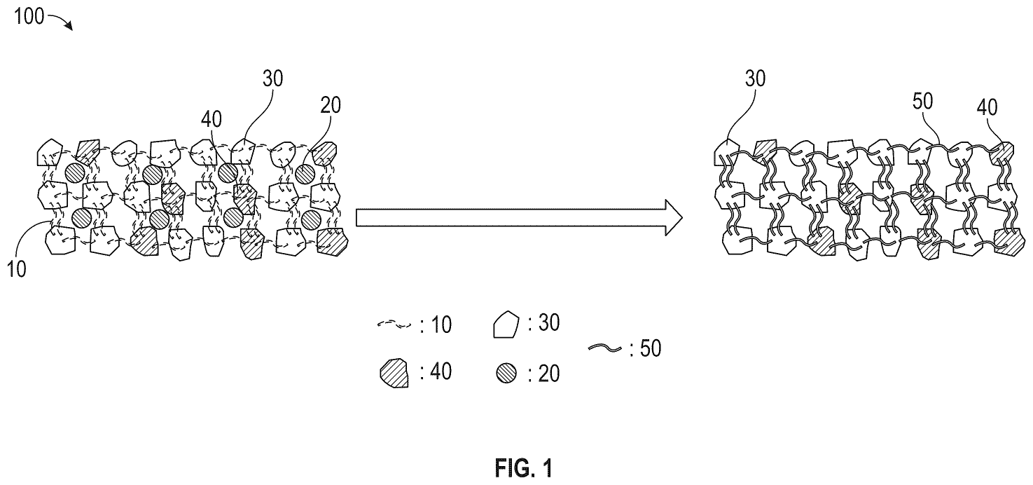

With reference to FIG. 1, first layer 100 may include PTFE fibrils 10, lithium 20, first solid-state electrolyte particles 30, and electrically conductive material 40. PTFE fibrils 10 within the first layer 100 may spontaneously react with lithium 20 also present in the first layer 100 according to the following reaction:

—(CF₂—CF₂)ₙ—+4nLi→2nC+4nLiF

forming fibrils 50 including carbon, fluorine, and lithium in-situ. The fibrils 50 including carbon, fluorine, and lithium may help reduce or prevent electrochemical reduction of the second layer and enable uniform Li⁺ flux with reduced or no lithium dendrite growth (e.g., providing electrochemical stability). Residual PTFE may inhibit the lithium-dendrite growth by reaction of the PTFE fibrils 10 and the lithium 20. A relatively thin second layer may be included in solid-state batteries as dendrite growth has been reduced or eliminated.

The fibrils 50 including carbon, fluorine, and lithium may provide for a robust first layer and help provide desirable electrochemical stability and high lithium-ion conductivity; The solid-state electrolyte particles 30 may promote a smooth lithium-ion pathway in the layer; and optional electrically conductive material 40 may help provide homogenous Li⁺ distribution in the interface, for example, due to excellent Li⁺ affinity, possibly enabling homogenous Li⁺ flux and fast Li⁺ migration across the interface including the fibrils 50 including carbon, fluorine, and lithium.

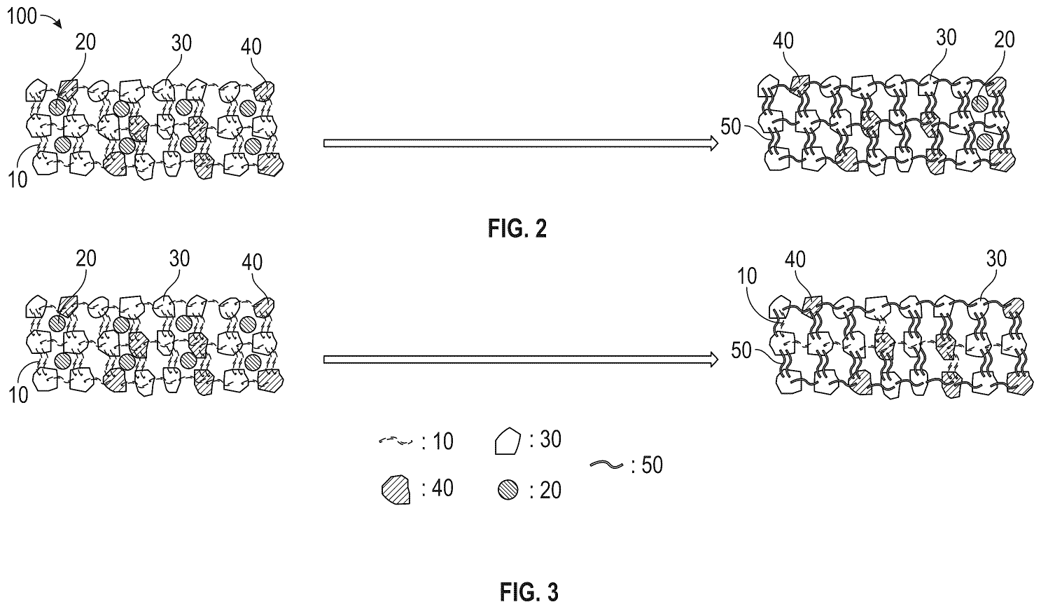

Differing beginning amounts of lithium and PTFE may result in different reaction product. The stoichiometric ratio of lithium to —[CF₂—CF₂]— is 4:1. As shown in FIG. 2, if lithium is in excess, the first layer including fibrils 50 including carbon, fluorine, and lithium may include lithium 20 separate from the fibrils 50. As shown in FIG. 3, if PTFE is in excess, a portion of the PTFE may be transformed into fibrils 50 including carbon, fluorine, and lithium and residual PTFE fibrils may remain (e.g., to help serve as a framework in the first layer).

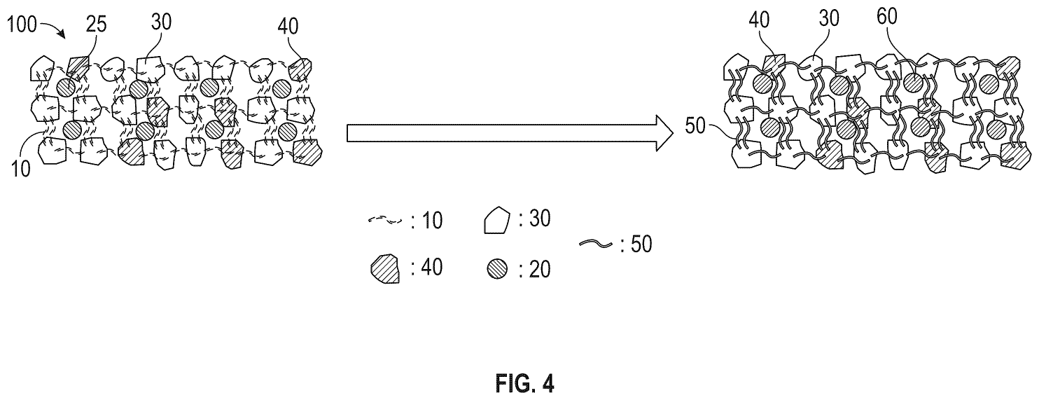

With reference to FIG. 4, the first layer 100 may include a mixture 25 of lithium and a lithium anode material, which may react according to the following reaction:

—(CF₂—CF₂)ₙ—+4nLi-M→2nC+4nLiF+4nM⁻

forming a first layer including fibrils 50 including carbon, fluorine, and lithium and a lithium anode material 60.

To form the first layer including fibrils 50 including carbon, fluorine, and lithium, first, solid electrolyte, PTFE powder, lithium powder, and optionally conductive material (e.g., graphite) are mixed. After continuous mixing and shearing, PTFE may fully fibrillated (e.g., fully fibrillated), which may effectively adhere lithium, solid electrolyte, and conductive material, holding them together like a “spider web”. Second, the mixture is rolled out (e.g., on an anode) to form a protection layer thereon. Third, fibrils 50 including carbon, fluorine, and lithium are formed in-situ and a solid-state battery is fabricated.

Without wishing to be bound by any theory, it is believed that the fibrils 50 including carbon, fluorine, and lithium may include small inorganic particles (e.g., including lithium) on a surface of a polymer chain of the PTFE fibrils 10. The fibrils 50 including carbon, fluorine, and lithium may have an average length of greater than or equal to about 2 μm to less than or equal to about 100 μm.

The fibrillated PTFE when first formed may be characterized as a fibril(s) including carbon and fluorine or fibril(s) including PTFE. The fibril(s) 50 including carbon, fluorine, and lithium formed in-situ from the fibril(s) including PTFE may also be characterized as a fibrils including carbon and fluorine, with such fibril(s) further including lithium.

The lithium present in the first layer prior to reaction of the PTFE fibrils 10 and the lithium 20 may be present in the form of a lithium foil, stabilized lithium metal powder, lithium metal, or a combination thereof. The lithium anode material that may be present in the first layer prior to reaction of the PTFE fibrils 10 and the lithium 20 may include, for example, a carbonaceous material (e.g., graphite, hard carbon, soft carbon, or a combination thereof), a metal oxide or sulfide (e.g., TiO₂, FeS, or a combination thereof), Li₄Ti₅O₁₂ and other lithium-accepting anode materials; a Li alloy-type material (e.g., silicon, silicon oxide (SiO) or a silicon compound, a transition-metal (e.g., Sn, In), or a combination thereof); or a combination thereof.

A solid-state electrochemical cell unit (also referred to as a “solid-state battery” and/or “battery”) that cycles lithium ions may include a negative electrode (i.e., anode), a positive electrode (i.e., cathode), and an electrolyte that occupies a space defined between the two or more electrodes. The electrolyte is a solid-state or semi-solid state separating layer that physically separates the negative electrode from the positive electrode. The electrolyte may include a first layer and a second layer. The first layer may include first solid-state electrolyte particles and fibrils including carbon, fluorine, and lithium. The second layer may include second solid-state electrolyte particles. Third solid-state electrolyte particles may be mixed with negative solid-state electroactive particles in the negative electrode, and fourth solid-state electrolyte particles may be mixed with positive solid-state electroactive particles in the positive electrode, so as to form a continuous electrolyte network, which may be a continuous lithium-ion conduction network.

A first current collector may be positioned at or near the negative electrode. The first current collector may be a metal foil, metal grid or screen, or expanded metal comprising copper or any other appropriate electrically conductive material known to those of skill in the art. A second current collector may be positioned at or near the positive electrode. The second current collector may be a metal foil, metal grid or screen, or expanded metal comprising aluminum or any other appropriate electrically conductive material known to those of skill in the art. The first current collector and the second current collector may be the same or different. The first current collector and the second electrode current collector respectively collect and move free electrons to and from an external circuit. For example, an interruptible external circuit and a load device may connect the negative electrode (through the first current collector) and the positive electrode (through the second current collector).

The skilled artisan will recognize that in certain variations, the first current collector may be a first bipolar current collector and/or the second current collector may be a second bipolar current collector. For example, the first bipolar current collector and/or the second bipolar current collector may be a cladded foil, for example, where one side (e.g., the first side or the second side) of the current collector includes one metal (e.g., first metal) and another side (e.g., the other side of the first side or the second side) of the current collector includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). In certain variations, the first bipolar current collector and/or second bipolar current collectors may be pre-coated, such as graphene or carbon-coated aluminum current collectors.

The battery can generate an electric current during discharge by way of reversible electrochemical reactions that occur when the external circuit is closed (to connect the negative electrode and the positive electrode) and when the negative electrode has a lower potential than the positive electrode. The chemical potential difference between the negative electrode and the positive electrode drives electrons produced by a reaction, for example, the oxidation of intercalated lithium, at the negative electrode, through the external circuit towards the positive electrode. Lithium ions, which are also produced at the negative electrode, are concurrently transferred through the electrolyte towards the positive electrode. The electrons flow through the external circuit and the lithium ions migrate across the electrolyte to the positive electrode, where they may be plated, reacted, or intercalated. The electric current passing through the external circuit can be harnessed and directed through the load device (in the direction of the arrows) until the lithium in the negative electrode is depleted and the capacity of the battery is diminished.

The battery can be charged or reenergized at any time by connecting an external power source (e.g., charging device) to the battery to reverse the electrochemical reactions that occur during battery discharge. The external power source that may be used to charge the battery may vary depending on the size, construction, and particular end-use of the battery. Some notable and exemplary external power sources include, but are not limited to, an alternating current (AC)-direct current (DC) converter connected to an AC electrical power grid though a wall outlet and a motor vehicle alternator. The connection of the external power source to the battery promotes a reaction, for example, non-spontaneous oxidation of intercalated lithium, at the positive electrode so that electrons and lithium ions are produced. The electrons, which flow back towards the negative electrode through the external circuit, and the lithium ions, which move across the electrolyte back towards the negative electrode, reunite at the negative electrode and replenish it with lithium for consumption during the next battery discharge cycle. As such, a complete discharging event followed by a complete charging event is considered to be a cycle, where lithium ions are cycled between the positive electrode and the negative electrode.

Though the described example includes a single positive electrode and a single negative electrode, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery may include a variety of other components that, while not described here, are nonetheless known to those of skill in the art. For example, the battery may include a casing, a gasket, terminal caps, and any other conventional components or materials that may be situated within the battery, including between or around the negative electrode, the positive electrode, and/or the electrolyte.

In many configurations, each of the first current collector, the negative electrode, the electrolyte, the positive electrode, and the second current collector are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery may further include electrodes connected in parallel to provide suitable electrical energy, battery voltage, and power for example, to yield a Parallel-Connected Elementary Cell Core (“PECC”).

The size and shape of the battery may vary depending on the particular applications for which it is designed. Battery-powered vehicles and hand-held consumer electronic devices are two examples where the battery would most likely be designed to different size, capacity, voltage, energy, and power-output specifications. The battery may also be connected in series or parallel with other similar lithium-ion cells or batteries to produce a greater voltage output, energy, and power if it is required by the load device. The battery can generate an electric current to the load device that can be operatively connected to the external circuit. The load device may be fully or partially powered by the electric current passing through the external circuit when the battery is discharging. While the load device may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device may also be an electricity-generating apparatus that charges the battery for purposes of storing electrical energy.

The electrolyte provides electrical separation (e.g., preventing physical contact) between the negative electrode and the positive electrode. The electrolyte also provides a minimal resistance path for internal passage of lithium ions. The electrolyte may be a membrane. That is, the electrolyte may be self-supporting with structural integrity and may be handled as an independent layer (e.g., removed from a substrate) rather than a coating formed on another element.

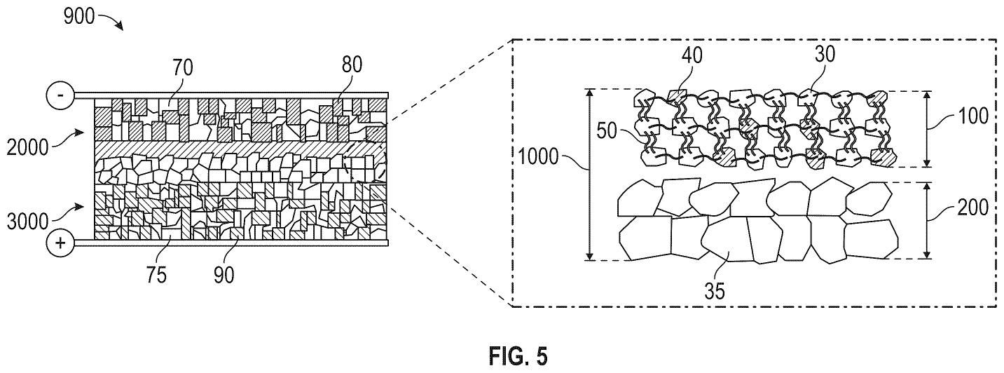

FIG. 5 illustrates a portion of a battery 900 including electrolyte 1000, negative electrode (e.g., anode) 2000, positive electrode (e.g., cathode) 3000. With reference to FIG. 5, in various aspects, the electrolyte 1000 includes a first layer 100 including first solid-state electrolyte particles 30, electrically conductive material 40, and fibrils 50 including carbon, fluorine, and lithium; and a second layer 200 including second solid-state electrolyte particles 35. The fibrils 50 including carbon, fluorine, and lithium may provide a structural framework for the first solid-state electrolyte particles 30 and optional electrically conductive material. For example, the first layer 100 may be in the form of a composite that comprises the first solid-state electrolyte particles 30, electrically conductive material 40, and the fibrils 50 including carbon, fluorine, and lithium. The first layer 100 may have a thickness greater than or equal to about 1 μm to less than or equal to about 40 μm. The second layer 200 may have a thickness greater than or equal to 5 μm to less than or equal to 60 μm.

The first layer is adjacent to the negative electrode (e.g., anode) 2000 and the second layer 200 is adjacent to positive electrode (e.g., cathode) 3000. As shown, negative electrode (e.g., anode) 2000 includes third solid-state electrolyte particles 70 and negative solid-state electroactive particles 80 and positive electrode (e.g., anode) 3000 includes fourth solid-state electrolyte particles 75 and positive solid-state electroactive particles 90.

Prior to reaction of the PTFE fibrils 10 and the lithium 20, the first layer 100 may include greater than or equal to about 1 wt. % to less than or equal to about 50 wt. % of the fibrils 10 (e.g., PTFE fibrils 10), greater than or equal to about 1 wt. % to less than or equal to about 15 wt. % of the lithium 20, greater than or equal to about 10 wt. % to less than or equal to about 40 wt. of the first solid-state electrolyte particles 30 (e.g., Li₆PS₅Cl or Li₁₀GeP₂S₁₂ (LGPS)), and optionally greater than 0 wt. % to less than or equal to about 60 wt. % of the electrically conductive material 40 (e.g., graphite). For example, the first layer can include 1 wt. % PTFE fibrils, 1.5 wt. % Li, 39.5 wt. % LPSCl, and 58 wt. % graphite. During reaction of the PTFE fibrils 10 and the lithium 20, the lithium can be incorporated into the fibrils, and after reaction of the PTFE fibrils 10 and the lithium 20, the first layer 100 may include greater than or equal to about 1 wt. % to less than or equal to about 65 wt. % of the fibrils 50 including carbon, fluorine, and lithium, greater than or equal to about 10 wt. % to less than or equal to about 40 wt. of the first solid-state electrolyte particles 30 (e.g., Li₆PS₅Cl or Li₁₀GeP₂S₁₂ (LGPS)), and optionally greater than 0 wt. % to less than or equal to about 60 wt. % of the electrically conductive material 40 (e.g., graphite).

In certain variations, the first solid-state electrolyte particles 30 and/or the second solid-state electrolyte particles 35 each independently may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm. The first solid-state electrolyte particles 30 and/or the second solid-state electrolyte particles 35 each independently may have an average particle diameter greater than or equal to 0.02 μm to less than or equal to 20 μm, optionally greater than or equal to 0.1 μm to less than or equal to 10 μm, and in certain aspects, optionally greater than or equal to 0.1 μm to less than or equal to 1 μm. For example, the first solid-state electrolyte particles 30 and/or the second solid-state electrolyte particles 35 each independently may comprise one or more sulfide-based particles, halide-based particles, hydride-based particles, or other solid-state electrolyte particles, for example, having low grain-boundary resistance. The second solid-state electrolyte particles 35 may be the same as or different from the first solid-state electrolyte particles 30.

In various aspects, the sulfide-based particles may include pseudobinary sulfide systems, pseudoternary sulfide systems, and/or pseudoquaternary sulfide systems. Example pseudobinary sulfide systems include systems include Li₂S—P₂S₅ systems (such as, Li₃PS₄, Li₂P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂ (LGPS)), Li₂SLi₂P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4 LiI·0.6 Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₂P_{2.9}Mn_{0.1}S_{10.7}I_{0.3}, and Li_{10.35}[Sn_{0.27}Si_{1.08}]P_{1.65}S₁₂.

In various aspects, the halide-based particles may include, for example only, Li₃YCl₆, Li₃InCl₆, Li₃YBr₆, LiI, Li₂CdCl₄, Li₂MgCl₄, LiCdl₄, Li₂ZnI₄, Li₃OCl, and combinations thereof; and the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof.

The negative electrode may be formed from a lithium host material that is capable of functioning as a negative terminal of a lithium-ion battery. For example, in certain variations, the negative electrode may be defined by a plurality of the negative solid-state electroactive particles. In certain instances, the negative electrode is a composite comprising a mixture of the negative solid-state electroactive particles and the third solid-state electrolyte particles. In each variation, the negative electrode may be in the form of a layer having a thickness greater than or equal to about 10 μm to less than or equal to about 5,000 μm, for example, greater than or equal to about 10 μm to less than or equal to about 500, μm and in certain aspects, optionally greater than or equal to about 10 μm to less than or equal to about 100 μm, for example, about 20 μm.

The negative electrode may include greater than or equal to about 30 wt. % to less than or equal to about 98 wt. %, and in certain aspects, optionally greater than or equal to about 50 wt. % to less than or equal to about 95 wt. %, of the negative solid-state electroactive particles, and greater than or equal to 0 wt. % to less than or equal to about 50 wt. %, and in certain aspects, optionally greater than or equal to about 5 wt. % to less than or equal to about 20 wt. %, of the third solid-state electrolyte particles. The negative electrode may include greater than or equal to 30 wt. % to less than or equal to 98 wt. %, and in certain aspects, optionally greater than or equal to 50 wt. % to less than or equal to 95 wt. %, of the negative solid-state electroactive particles, and greater than or equal to 0 wt. % to less than or equal to 50 wt. %, and in certain aspects, optionally greater than or equal to 5 wt. % to less than or equal to 20 wt. %, of the third solid-state electrolyte particles.

The negative solid-state electroactive particles may be lithium-based, for example, a lithium alloy or lithium metal. In other variations, the negative solid-state electroactive particles may be silicon-based comprising, for example, a silicon alloy and/or silicon-graphite mixture. In still other variations, the negative electrode may be a carbonaceous anode and the negative solid-state electroactive particles may comprise one or more negative electroactive materials, such as graphite, graphene, hard carbon, soft carbon, and carbon nanotubes (CNTs). In still further variations, the negative electrode may comprise one or more negative electroactive materials, such as lithium titanium oxide (Li₄Ti₅O₁₂); one or more metal oxides, such as TiO₂ and/or V₂O₅; and/or metal sulfides, such as FeS. The negative solid-state electroactive particles may be selected from the group including, for example only, lithium, graphite, graphene, hard carbon, soft carbon, carbon nanotubes, silicon, silicon-containing alloys, tin-containing alloys, and/or other lithium-accepting materials.

The third solid-state electrolyte particles may be the same as or different from the first solid-state electrolyte particles and/or the second solid-state electrolyte particles. For example, the third solid-state electrolyte particles may comprise one or more sulfide-based particles, halide-based particles, hydride-based particles, or other solid-state electrolyte particles, for example, having low grain-boundary resistance.

In certain variations, the negative electrode may further include one or more conductive additives and/or binder materials. For example, the negative solid-state electroactive particles (and/or third solid-state electrolyte particles) may be optionally intermingled with one or more electrically conductive materials that provide an electron conduction path and/or at least one polymeric binder material that improves the structural integrity of the negative electrode.

For example, the negative solid-state electroactive particles (and/or third solid-state electrolyte particles) may be optionally intermingled with binders, such as sodium carboxymethyl cellulose (CMC), styrene ethylene butylene styrene copolymer (SEBS), styrene butadiene styrene copolymer (SBS), PVDF, PTFE, ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

In various aspects, the negative electrode may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders. The negative electrode may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

The positive electrode may be formed from a lithium-based or electroactive material that can undergo lithium intercalation and deintercalation while functioning as the positive terminal of the battery. For example, in certain variations, the positive electrode may be defined by a plurality of the positive solid-state electroactive particles. In certain instances, the positive electrode is a composite comprising a mixture of the positive solid-state electroactive particles and the fourth solid-state electrolyte particles. In each variation, the positive electrode may be in the form of a layer having a thickness greater than or equal to about 10 μm to less than or equal to about 5,000 μm, for example, greater than or equal to about 10 μm to less than or equal to about 500 μm, and in certain aspects, optionally greater than or equal to about 10 μm to less than or equal to about 100 μm, for example, about 40 μm.

The positive electrode may include greater than or equal to about 30 wt. % to less than or equal to about 98 wt. %, and in certain aspects, optionally greater than or equal to about 50 wt. % to less than or equal to about 95 wt. %, of the positive solid-state electroactive particles, and greater than or equal to 0 wt. % to less than or equal to about 50 wt. %, and in certain aspects, optionally greater than or equal to about 5 wt. % to less than or equal to about 20 wt. %, of the fourth solid-state electrolyte particles. The positive electrode may include greater than or equal to 30 wt. % to less than or equal to 98 wt. %, and in certain aspects, optionally greater than or equal to 50 wt. % to less than or equal to 95 wt. %, of the positive solid-state electroactive particles, and greater than or equal to 0 wt. % to less than or equal to 50 wt. %, and in certain aspects, optionally greater than or equal to 5 wt. % to less than or equal to 20 wt. %, of the fourth solid-state electrolyte particles.

In certain variations, the positive electrode may be one of a layered-oxide cathode, a spinel cathode, and a polyanion cathode. For example, in the instances of a layered-oxide cathode (e.g., rock salt layered oxides), the positive solid-state electroactive particles may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. The positive solid-state electroactive particles may comprise one or more positive electroactive materials selected from the group consisting of LiCoO₂, LiNiₓMn_{y}CO_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles may be coated (for example, by LiNbO₃ and/or Al₂O₃) and/or the positive electroactive material may be doped (for example, by aluminum and/or magnesium).

The fourth solid-state electrolyte particles may be the same as or different from the first solid-state electrolyte particles, the second solid-state electrolyte particles, and/or the third solid-state electrolyte particles. For example, the fourth solid-state electrolyte particles may comprise one or more sulfide-based particles, halide-based particles, hydride-based particles, or other solid-state electrolyte particles, for example, having low grain-boundary resistance.

In certain variations, the positive electrode may further include one or more conductive additives and/or binder materials. For example, the positive solid-state electroactive particles (and/or fourth solid-state electrolyte particles) may be optionally intermingled with one or more electrically conductive materials that provide an electron conduction path and/or at least one polymeric binder material that improves the structural integrity of the positive electrode.

For example, the positive solid-state electroactive particles (and/or fourth solid-state electrolyte particles) be optionally intermingled with binders, such as sodium CMC, SEBS, SBS, PVDF, PTFE, EPDM rubber, NBR, SBR, PEO, and/or LiPAA binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

In various aspects, the positive electrode may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders. The positive electrode may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

In various aspects, the negative electrode may be prepared using wet-coating process, without ionic liquids. However, in other variations, a negative electrode may be prepared using a solvent-free process.

Certain features of the current technology are further illustrated in the following non-limiting examples.

### EXAMPLES

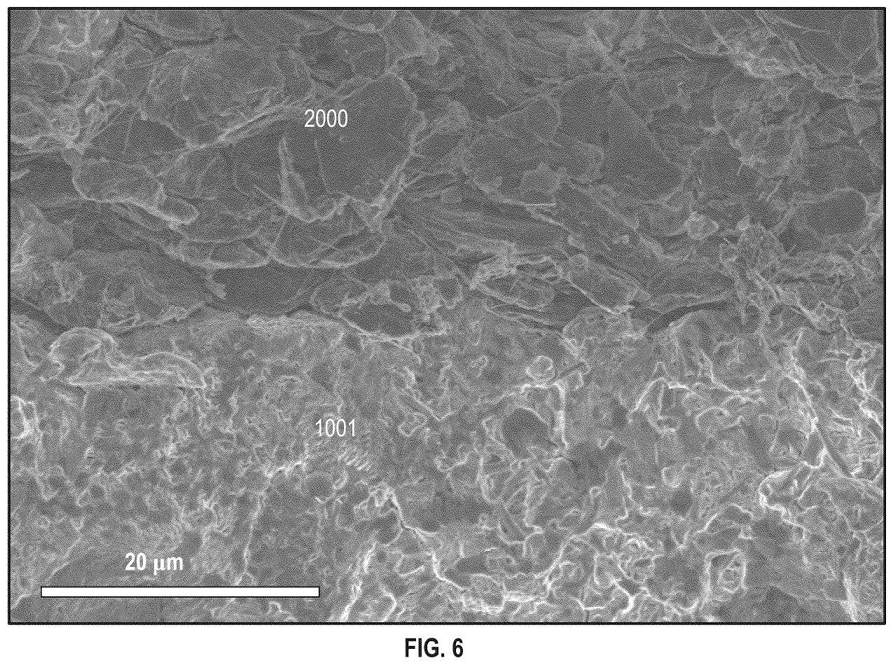

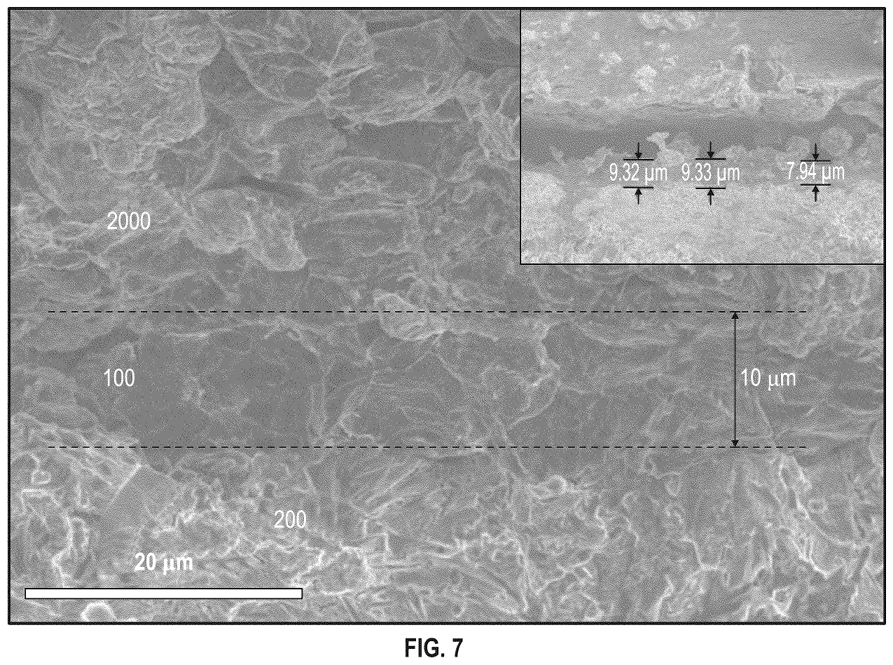

FIG. 6 is a scanning electron microscopy (SEM) image of a Comparative Example showing an anode including graphite 2000 and an electrolyte 1001 including Li₆PS₅Cl (LPSCl) solid-state electrolyte particles. FIG. 7 is a SEM image of an Example showing an anode 2000 including graphite and an electrolyte including a first layer 100 including LPSCl solid-state electrolyte particles and fibrils including carbon, fluorine, and lithium and having a thickness of 10 micrometers (μm) adjacent to the anode 2000 including graphite and a second layer 200 including LPSCl solid-state electrolyte particles opposite the anode including graphite. The inset of FIG. 7 shows delaminated layers to more accurately measure the thickness of the first layer. The fibrils including carbon, fluorine, and lithium can be confirmed by Energy-dispersive X-ray spectroscopy mapping.

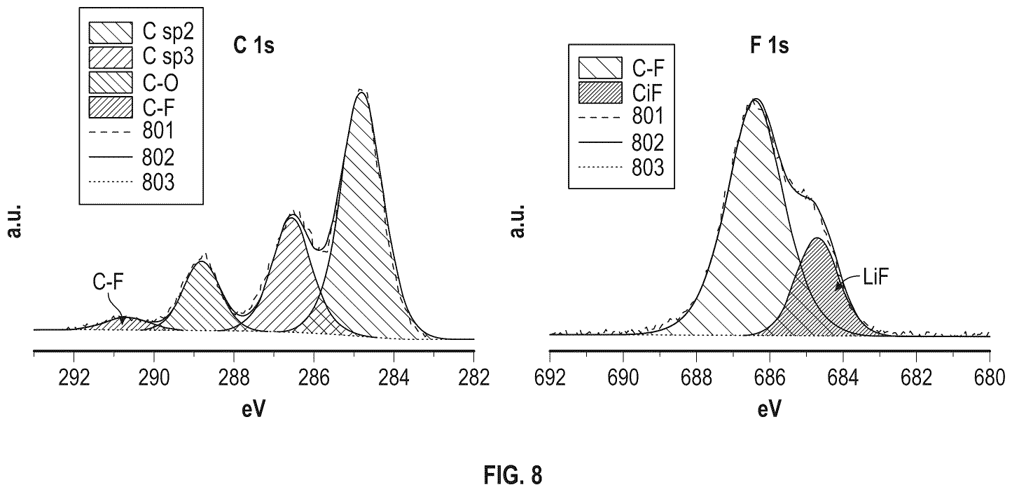

FIG. 8 is a graphical illustration representing x-ray photoelectron spectroscopy (XPS) analysis of the first layer of the Example, in which the x-axis represents binding energy (electronvolts (eV)) and the y-axis 702 represents intensity (a.u.) and plot 801 is the original, plot 802 is fitted, and plot 803 is the baseline. As illustrated, the C1s and F1s XPS figure shows the presence of residual C—F bond, which indicates that lithium is completed consumed. If there is residual lithium source, it will continue to react with C—F bond to form LiF.

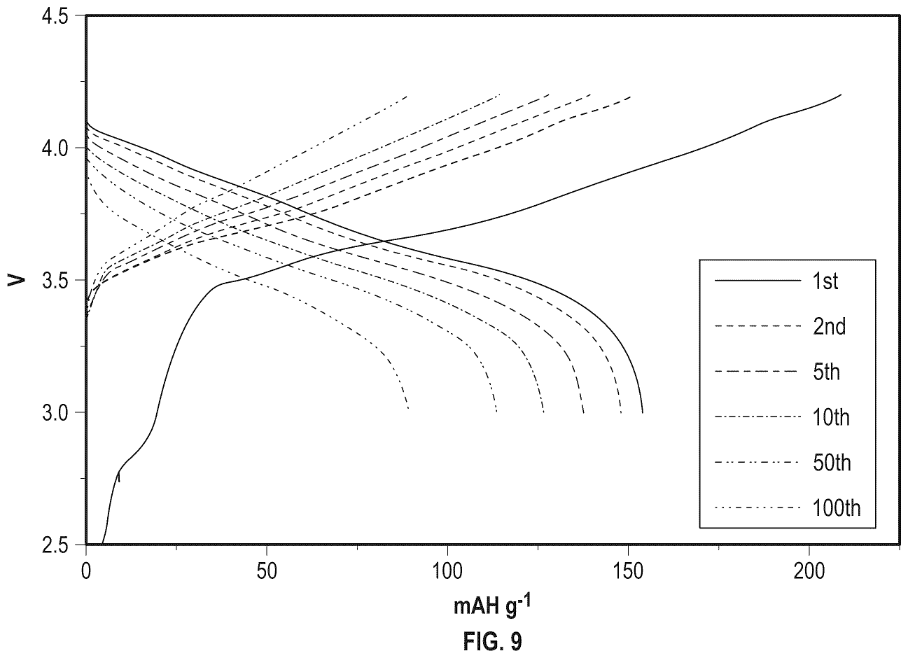

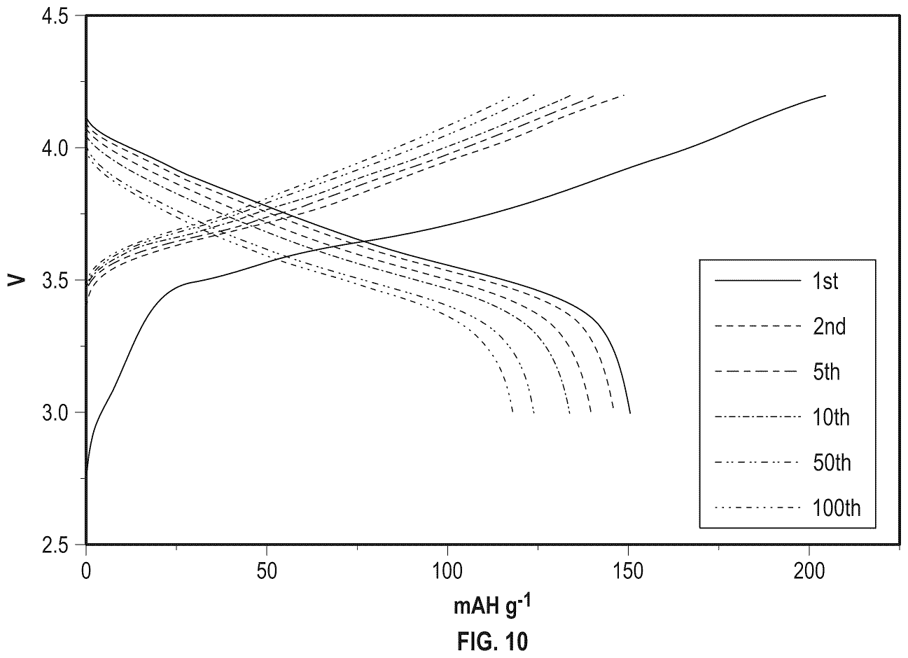

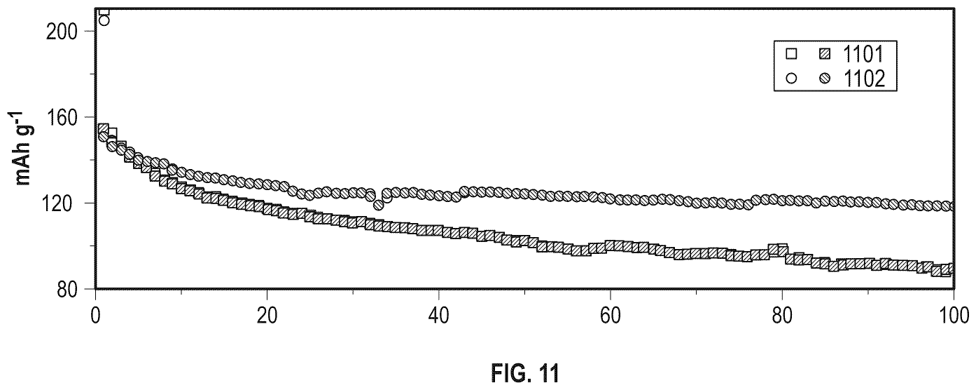

FIG. 9 is a graphical illustration demonstrating electrochemical performance of the Comparative Example, in which the x-axis represents specific capacity (milliampere-hours per gram (mAh g⁻¹)) and the y-axis represents voltage (volts (V)). FIG. 10 is a graphical illustration demonstrating electrochemical performance of the Example, in which the x-axis represents specific capacity (mAh g⁻¹) and the y-axis represents voltage (V). FIG. 11 is a graphical illustration demonstrating electrochemical performance of the Comparative Example (1101) and the Example (1102), in which the x-axis represents cycle number and the y-axis represents specific capacity (mAh g⁻¹). As shown in FIGS. 9-11, the Example exhibited improved capacity retention as compared to the Comparative Example. Without wishing to be bound by any theory, it is believed that better cycling performance is enabled by protection provided by the fibrils including carbon, fluorine, and lithium.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrolyte for use in an electrochemical cell, the electrolyte comprising:
a first layer having a thickness of about 1 μm to about 40 μm; and
a second layer having a thickness of about 5 μm to about 60 μm,
wherein the first layer comprises, based on a total weight of the first layer:
about 10 wt. % to about 40 wt. % of first solid-state electrolyte particles,
about 1 wt. % to about 15 wt. % of lithium, and
about 1 wt. % to about 65 wt. % of fibrils comprising carbon and fluorine, and
wherein the second layer comprises second solid-state electrolyte particles.

2. The electrolyte of claim 1, wherein the first layer further comprises greater than 0 to about 60 wt. % of an electrically conductive material.

3. The electrolyte of claim 1, wherein the first solid-state electrolyte particles are selected from the group consisting of: solid-state sulfide electrolyte particles, solid-state halide electrolyte particles, solid-state hydride electrolyte particles, and combinations thereof.

4. The electrolyte of claim 1, wherein the second solid-state electrolyte particles are selected from the group consisting of: solid-state sulfide electrolyte particles, solid-state halide electrolyte particles, solid-state hydride electrolyte particles, and combinations thereof.

5. The electrolyte of claim 1, wherein the fibrils comprising carbon and fluorine comprise polytetrafluoroethylene.

6. The electrolyte of claim 5, wherein the fibrils comprising polytetrafluoroethylene are present in an amount of about 1 wt. % to about 50 wt. %, based on a total weight of the first layer.

7. The electrolyte of claim 5, wherein the lithium is present in the form of a lithium foil, stabilized lithium metal powder, lithium metal, or a combination thereof.

8. The electrolyte of claim 5, wherein the first layer further comprises a lithium anode material.

9. The electrolyte of claim 1, wherein the fibrils comprising carbon and fluorine further comprise lithium.

10. The electrolyte of claim 9, wherein the first layer further comprises a lithium anode material.

11. An electrochemical cell that cycles lithium ions, the electrochemical cell comprising:
an electrolyte comprising:
a first layer having a thickness of about 1 μm to about 40 μm; and
a second layer having a thickness of about 5 μm to about 60 μm,
wherein the first layer comprises, based on a total weight of the first layer:
about 10 wt. % to about 40 wt. % of first solid-state electrolyte particles;
about 1 wt. % to about 15 wt. % of lithium;
about 1 wt. % to about 65 wt. % of fibrils comprising carbon and fluorine; and
greater than 0 to about 60 wt. % of an electrically conductive material, and
wherein the second layer comprises second solid-state electrolyte particles.

12. The electrochemical cell of claim 11, wherein the first solid-state electrolyte particles are selected from the group consisting of: solid-state sulfide electrolyte particles, solid-state halide electrolyte particles, solid-state hydride electrolyte particles, and combinations thereof.

13. The electrochemical cell of claim 11, wherein the second solid-state electrolyte particles are selected from the group consisting of: solid-state sulfide electrolyte particles, solid-state halide electrolyte particles, solid-state hydride electrolyte particles, and combinations thereof.

14. The electrochemical cell of claim 11, wherein the electrochemical cell further comprises at least one first electrode, wherein the at least one first electrode comprises:
first solid-state electroactive particles, and
third solid-state electrolyte particles.

15. The electrochemical cell of claim 14, wherein the electrochemical cell further comprises at least one second electrode, wherein the at least one second electrode comprises:
second solid-state electroactive particles, wherein the second solid-state electroactive particles are different from the first solid-state electroactive particles, and
fourth solid-state electrolyte particles.

16. The electrochemical cell of claim 13, wherein the fibrils comprising carbon and fluorine comprise polytetrafluoroethylene.

17. The electrochemical cell of claim 13, wherein the fibrils comprising carbon and fluorine further comprise lithium.

18. An electrolyte for use in an electrochemical cell, the electrolyte comprising:
a first layer having a thickness of about 1 μm to about 40 μm; and
a second layer having a thickness of about 5 μm to about 60 μm,
wherein the first layer comprises, based on a total weight of the first layer;
about 10 wt. % to about 40 wt. % of first solid-state electrolyte particles, wherein the first solid-state electrolyte particles comprises solid-state sulfide electrolyte particles;
about 1 wt. % to about 15 wt. % of lithium;
about 1 wt. % to about 65 wt. % of fibrils comprising carbon and fluorine; and
greater than 0 to about 60 wt. % of an electrically conductive material, and
wherein the second layer comprises second solid-state electrolyte particles.

19. The electrolyte of claim 17, wherein the first solid-state electrolyte particles further comprise solid-state halide electrolyte particles, solid-state hydride electrolyte particles, or a combination of solid-state halide electrolyte particles and solid-state hydride electrolyte particles.

20. The electrolyte of claim 17, wherein the fibrils comprising carbon and fluorine are prepared from a starting polytetrafluoroethylene material having an average particle size greater than or equal to about 2 μm to less than or equal to about 2,000 μm.
